(19) United States
(12) Patent Application Publication
(10) Pub. No.: US 2002/0124102 A1
(43) Pub. Date: Sep. 5, 2002

(54) Non-zero credit management to avoid message loss

(75) Inventors: kevin G. Kramer, Wappingers Falls, NY (US); Henry Horngren Tsou, San Jose, CA (US); Chan Y. Ng, San Jose, CA (US); Christopher Scott Taylor, Rochester, MN (US); Kwan Sang Yap, San Jose, CA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: International Business Machines Corporation, Armonk, NY (US)

(21) Appl. No.: 09/797,499

(22) Filed: Mar. 1, 2001

(51) Int. Cl. G06F 15/16

(52) U.S. Cl. 709/234

(57) ABSTRACT

A device for controlling the flow of command messages in a network in order to alleviate full queue situations that may result in an overrun of commands. The device comprises a counter circuit for determining the number of buffers available in the command queue and a control circuit for controlling the flow of command frames. The control circuit includes a first and second means for storing and is responsive to a status of the command queue and control logic.

### FIELD OF THE INVENTION

This invention relates to the field of data processing systems and, more particularly to a system and method for controlling the flow of messages in network environments.

### BACKGROUND OF THE INVENTION

In order to provide an appropriate context for an understanding and appreciation of the present invention, reference may be made to the prior art which includes a number of teachings regarding the management and control of data of interconnected devices, i.e., networked computers, disk drives, and other sub-systems and devices. In U.S. Pat. No. 5,737,535 for example there is disclosed a computer system for connection in a network, which has a number of other devices each of which may receive communications from the computer system. The computer system includes a network interface and a message transmission control circuit. The network interface establishes a communications session with a selected one of the other devices as a destination for transmitting messages to the selected device. The message transmission control circuit enables the network interface to establish a communications session and transmit messages thereover with the selected device. The message transmission control circuit initially enables the network interface to transmit a number of messages corresponding to a login credit value selected for the selected device. Thereafter, the message transmission control circuit enables the network interface to transmit messages based on flow control information received from the selected device. This reduces the amount of overhead required at the beginning of a communication session by allowing the computer system to transmit a number of messages corresponding to the selected login credit value prior to getting flow control information from the selected device. U.S. Pat. No. 5,737,535 is incorporated herein by reference.

In U.S. Pat. No. 5,598, 541 there is disclosed an architecture for implementing the FC-1 transmission protocol and the FC-2 framing protocol in a Fibre Channel circuit including exchange and sequence management. U.S. Pat. No. 5,598,541 is incorporated herein by reference.

In U.S. Pat. No. 5,638,518 there is disclosed an overall implementation for a Fibre Channel Node, including disclosure of 8 bit to 10 bit conversion and control of primitives and sequences by a node loop port. U.S. Pat. No. 5,638,518 is incorporated herein by reference.

Fibre Channel Arbitrated Loops (FCAL) use a mechanism referred to as BB Credit to control the flow of frames between ports that are OPEN or OPENED on a loop. An OPEN port is defined as the port that initiated the connection with the OPENED port. Ports may not send a frame to a destination port without receiving credit in the form of a R_RDY primitive from the intended destination port.

In order to improve performance, an arbitrated LOOP port may advertise a login BB credit value. The advertised login BB credit value is a guarantee of a number of frames a port advertises as providing credit for in advance of sending R_RDY's. Thus, the login BB credit allows a port to open a destination port and send one or more frames thereto without having to wait for the destination port to first return a R_RDY. For example, an initiating port, such as a computer system, may send an OPEN to a disk drive advertising a non-zero amount of login BB credit, and immediately send a number of frames to the opened destination drive without having to wait for a R_RDY. Accordingly, a round trip delay before frame transmission can begin is eliminated. The latency time savings may be significant, particularly in large loops.

Non-Zero login credit presents a unique problem however in that a port advertising n login credits is guaranteeing that n buffers are available to receive frames. The guarantee must be satisfied. The problem arises when a port advertising login credits is opened and closed repeatedly whereby the port may be “overrun” with frames. The only way to prevent the repeated opening and closing of a port is for that port to withhold a CLOSE, thereby holding the established circuit open. The reception of data frames does not usually present a problem since data frames are solicited and a receiving device typically has a reserved area for incoming data frames. Command frames are unsolicited and are stored in a command queue prior to execution. If a sufficiently large number of command frames are received at a port faster than the port can execute the received commands a full queue situation results. Execution of the command frames may be slowed due to the amount of traffic on the loop. The full command queue and port are consequently “overrun”. Holding a CLOSE in this situation may prevent additional frames from being received yet it may also prevent execution of pending commands since loop access may be needed in order to execute pending commands that would free queue space. Since the port can no longer accommodate incoming commands, frames must be dropped to free buffer space and close the loop. Dropping frames, though permissible in Fibre Channel (FC), is highly undesirable.

A primary object of the present invention is to alleviate the problem of frame (message) loss, particularly in systems employing Login Credit and BB Credit.

### SUMMARY OF THE INVENTION

The present invention avoids the dropped frames (i.e., messages) situation by using a two-tier approach involving a specialized control circuit having two threshold registers. A Queue Warning Threshold triggers a first tier set of actions when the command queue's free slot count drops below a threshold value indicating that the command queue is approaching a full condition. The second register is a Prevent Close Threshold that triggers a second tier of actions when the command queue is even closer to a full condition. Both threshold values are programmable, for example via a microcode register write.

The present invention is a device and method for controlling the flow of command messages in a network in order to alleviate full queue situations that can result in an overrun of commands, leading to dropped command frames. The device comprises a counter circuit for determining the number of buffers available in the command queue and a control circuit for controlling the flow of frames into the port, along with corresponding code. The control circuit includes a first and second means for storing responsive to a status of said command queue and control logic. The storing means preferably comprises a first and second threshold register.

The above and other objects, advantages, and benefits of the present invention will be understood by reference to following description and drawings.

### BRIEF DESCRIPTION OF THE DRAWINGS

FIG. 1 is a high level block diagram of a system embodying the invention described herein;

FIG. 2 is a schematic logic diagram of a destination buffer count available circuit comprising a portion of the Loop and Credit Control circuit of FIG. 1 for controlling the transmission of flow control signals (R_RDY), which in turn controls the transmission of frames or messages from a source device in accordance with the present invention; and

FIGS. 3 and 4 are schematic diagrams illustrating control logic and port control logic aspects of FIG. 1.

### DETAILED DESCRIPTION OF THE INVENTION

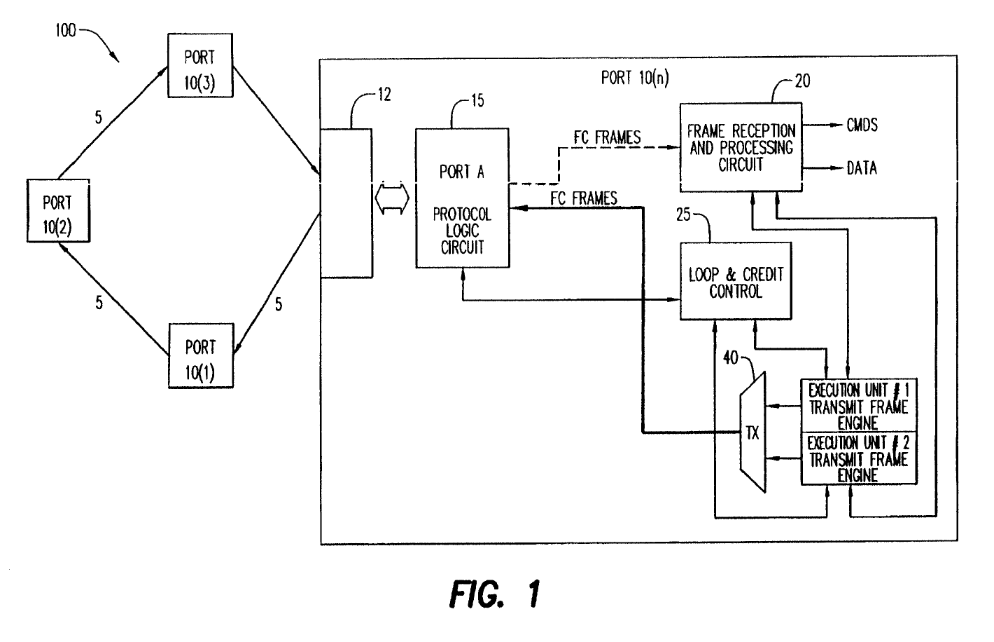

FIG. 1 is a high level block diagram of a communication network 100 embodying the present invention. The network includes a plurality of devices interfaced with the network via interface ports. The devices may be computers, disk drive storage units, etc. The ports of an exemplary network are shown in FIG. 1 as ports 10(1), 10(2), 10(3) and 10(n). As shown, the plurality of ports are interconnected for communication therebetween. Fibre channel (FC) command messages in the form of frames are received by the network interface 12 and communicated to port protocol logic 15 that determines the communication protocol of the port 10(n), as will be discussed in greater detail below. FC frames are sent to frame reception and processing circuit 20 where command messages and data are processed and dispatched for use by the device. Frame reception and processing circuit 20 and transmitter 40 receive instructions for the execution of commands and dispatch of data from execution unit 1 and execution unit 2. The execution engines communicate with network loop and credit control circuit 25 to determine when frames may be transmitted. Network loop and credit control circuit 25 primarily controls the flow of FC data and command messages. Port protocol logic 15 controls the protocol (e.g., OPEN full duplex, OPEN half duplex, or CLOSE) for the port as shown in FIG. 1.

Network loop and credit control circuit 25 controls the flow of FC data and command messages in accordance with the present invention to avoid a loss of command frames due to a queue full condition in, for example, a fibre channel network environment. The network loop and credit control circuit 25 operates to adjust the flow of FC data and commands in order to avoid a communication situation on the network wherein FC frames are dropped due to full command queues that are unable to accommodate received commands at port 10(n) while initiating ports on the network continue to send commands. That is, the port is “overrun” with commands.

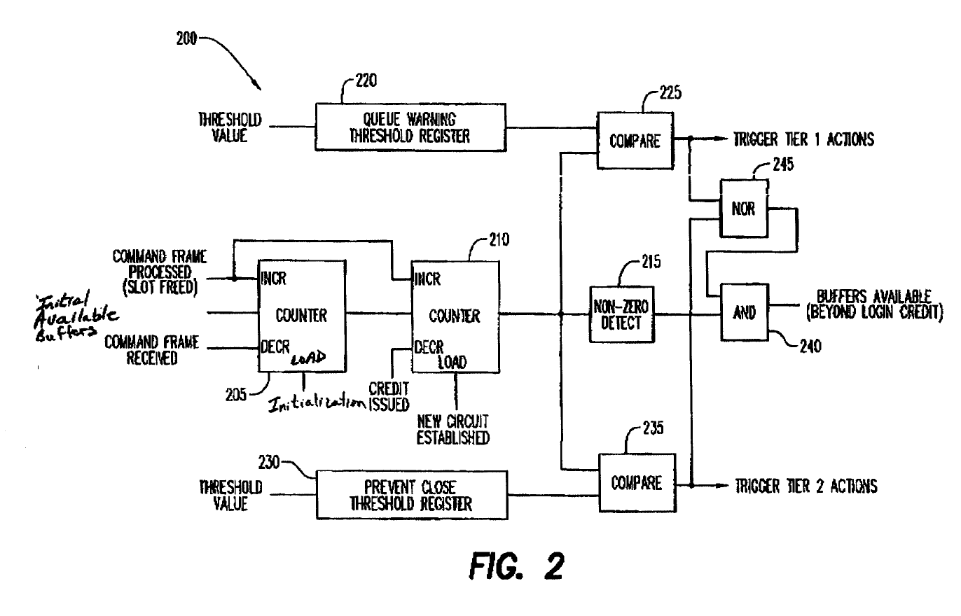

FIG. 2 depicts a schematic diagram of the destination buffer count available control circuit 200 used to control the flow of command messages in a FC protocol network environment. Circuit 200 forms part of the Loop and Credit control unit 25 (FIG. 1), and includes control logic for maintaining an accounting of the buffers slots available at destination port 10(n) and for controlling the transmission of flow control signals (R_RDY) to another network port, for example a source port 10(3). The destination buffer count available circuit 200 preferably includes a command frame counter 205; a reserved buffer counter 210; a non-zero detect circuit 215; and two storage means, preferably in the form of two registers, a Queue Warning Threshold Register 220 and a Prevent Close Threshold Register 230 for providing a two-tier FC command frame loss avoidance scheme. The storage means, in the form of the two registers, function to produce the unique result of the present invention, i.e., they operate in the network system described to preclude the loss of command messages due to overloading of the receiving port.

The command frame counter 205 is initially loaded with a value corresponding to the number of buffers available to accept commands at port 10(n). When a command frame is received and allocated a buffer, a Command Frame Received signal is received at command frame counter 205 that decrements the command frame counter 205. Counter 205 is decremented since a buffer at the destination port 10(n) is allotted to the received command frame. Thus, the buffer cannot be used to accommodate another command.

When the port 10(n) processes a command frame, a Command Frame Processed signal is received at command frame counter 205 that increments counter 205. Command frame counter 205 is incremented to account for buffers freed. Freed buffers are available for allocation, for example, when a command frame is processed by port, 10(n). Thus, the command frame buffer counter 205 maintains a count corresponding to the number of buffers available for reception of command messages at a FC destination port.

Reserved buffer counter 210 provides a count of the buffer slots reserved for allocation of commands. When a new circuit is established (i.e., a communication session is initiated with another port) a New Circuit Established signal is asserted by the control logic. The New Circuit Established signal from protocol logic circuit 15 (FIG. 1) to reserved buffer counter 210 provides a signal indicating counter 210 should load the count from counter 205. The Command Frame Processed signal to counter 205 that increments counter 205, as discussed above, also increments reserved buffer counter 210. Reserved buffer counter 210 is incremented in response to an assertion of the Command Frame Processed signal since a buffer is freed when a command frame is processed. Reserved buffer counter 210 is decremented by a Credit Issued signal when a credit is issued (i.e., flow control signal R_RDY is sent), and consequently a buffer reserved for a potentially incoming frame is no longer available to accommodate received commands. Therefore, the output of reserved buffer counter 210 provides a count of the buffer slots available to allocate to frames during a given connection. Counter 210 is reset at the beginning of a new circuit connection.

The output of reserved buffer counter 210 is presented to a non-zero detect circuit 215, as well as to a comparator 225 and a comparator 235. The non-zero detect circuit 215 provides an output representative of whether the determined command buffer count is non-zero (i.e., indicative that there are command buffers available). Non-zero detect circuit 215 outputs a Non-zero Buffer Available signal to indicate that the value from counter 210 is a non-zero value or a zero value (i.e., indicative that there are no command buffers available).

Queue Warning Threshold Register 220 provides a threshold value to comparator 225. The Queue Warning Threshold Register is programmable using microcode to write a warning threshold value thereto. Comparator 225 compares the value of Queue Warning Threshold Register 220 value and the Command Queue Free Slot Count value from counter 210. An indication that the command queue is approaching a full level occurs when the Command Queue Free Slot Count from counter 210 is less than the Queue Warning Threshold Register 220 value. In this case, a Tier 1 trigger signal is asserted and tier 1 actions are triggered to control the transmission of FC commands.

Tier 1 actions triggered when the Command Queue Free Slot Count from counter 210 is below the Queue Warning Threshold Register 220 value include corrective actions to adjust the ratio of incoming command frames to executed commands. Tier 1 corrective actions preferably include modifying the OPEN behavior of the port 10(n) from Open Full Duplex to Open Half Duplex. That is, the port will open other ports in Half Duplex mode only. Accordingly, the ports opened by the port implementing Tier 1 actions will not transmit any further command frames while opened by the port implementing Tier 1. Port 10(n) also preferably reduces the number of R_RDY signals sent to OPEN initiators on the network to port 10(n)'s advertised login credit value. Port 10(n) preferably does not issue any further R_RDY messages to the ports in tenancy. Port 10(n) continues to operate in the Tier 1 mode so as long as the Command Queue Free Count is below the Queue Warning Threshold.

Additionally, Tier 1 actions may include the pausing or termination of a command currently being executed in order to use available received flow control bandwidth to send queue full status messages to the currently connected port. Each queue full status frame that is successfully transmitted will free up a command slot. Commands from selected initiators may be rejected in this manner in order to reverse the trend in the ratio of incoming commands to executed commands.

Prevent Close Threshold Register 230 provides a threshold value to comparator 235. The Queue Warning Threshold Register is also programmable using microcode. Comparator 235 compares the value of Prevent Close Threshold Register 230 and the Command Queue Free Slot Count value from counter 210. An indication that the command queue is even closer to being full than the scenario discussed above occurs when the Command Queue Free Slot Count from counter 210 is less than the Prevent Close Threshold Register 230 value. In this case, a Tier 2 trigger signal is generated by comparator 235 to trigger Tier 2 actions.

Note that the Prevent Close Threshold Register value is less normally than the Queue Warning Threshold Register 220 value and is preferably set to trigger before the command queue is completely filled in order to allow for additional frames to be received while corrective Tier 2 actions are implemented. Thus, the two registers provide two levels of indication and action in the event of the command queue approaching a full state so as to avoid a situation wherein the port is overrun by commands received faster than the commands can be executed.

Tier 2 actions are triggered when the Command Queue Free Slot Count from counter 210 is less than the Prevent Close Threshold Register 230 value and include the Tier 1 actions discussed above. Additionally, a Prevent Close condition is established by port 10(n) acting in the Tier 2 mode. Preventing the port from closing preferably allows the port to clean its buffer queues by rejecting commands received therein via a queue full status message before releasing the port's current communication circuit and possibly receiving additional command frames on new circuits. The port will also attempt to send queue full status messages to other ports initiating commands. In this manner, all commands that can be terminated by a queue full status message are thus terminated by the sent queue full status messages. The Prevent Close condition is preferably cleared by a signal from port control logic firmware once the number of commands in the command queue is reduced to a sufficient level, preferably well below the Prevent Close threshold value. However, firmware may close the port at any time in order to attempt to open another initiator, sending additional queue full status messages and freeing additional slots.

Additionally, Tier 2 actions may include the pausing or termination of commands currently being executed in order to use all available received flow control bandwidth to send queue full status messages to the currently connected port.

The outputs of comparators 225 and 235 supply the input signals to NOR gate 245. The output of NOR gate 245 provides one input to AND gate 240 and the output of the non-zero detect circuit 215 provides the other input to AND gate 240. It should be appreciated by those skilled in the art that only when both comparators 225 and 235 supply a logic zero and non-detect zero circuit 215 supplies a logic 1 (i.e., representative of a non-zero count) will the Buffers Available signal output by AND gate 240 be asserted. When non-zero detect circuit 215 detects a zero count and thus outputs a logic zero to indicate that there are no more command buffers available, there are necessarily no buffers available. When either the Tier 1 or Tier 2 actions are triggered, then the control logic of the present invention takes the corrective actions discussed above [limits the availability of buffers] so as to avoid FC frame loss.

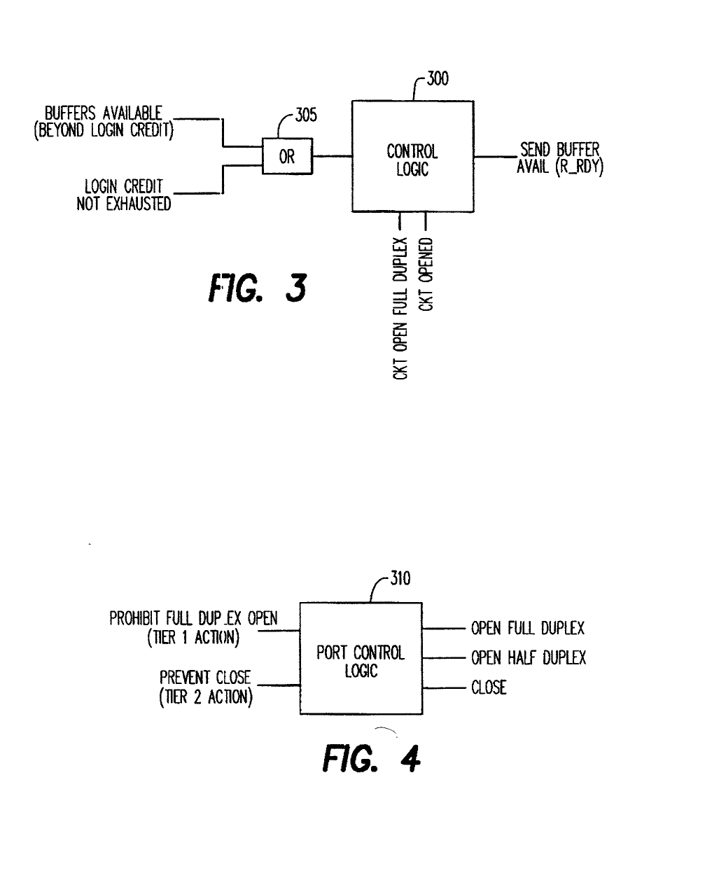

In FIG. 3, further control logic is depicted. The Buffers Available signal from AND gate 240 and a Login Credit Not Exhausted signal is input to OR gate 305. The Login Credit Not Exhausted signal input to OR gate 305 is provided by the Loop and Credit Control circuit 20 (FIG. 1). The output of OR gate 305 is presented to control logic 300 that controls the transmission of frames between communicating ports by sending a Send Buffer Available signal/Flow Control signal (i.e., a primitive R_RDY) to other ports. That is, R_RDY signals are sent to initiating ports to notify the initiating ports that the destination port is ready to receive a frame. As shown, the control logic also has input signals to indicate whether port 10(n) has initiated the FULL DUPLEX opening of a communication circuit with another port according to a Ckt Open Full Duplex or whether port 10(n) is itself opened by another port according to a Ckt Opened signal. Both of these situations require credit to be issued. Destination buffer count available circuit 200 and control logic 300 are preferably implemented as part of Loop and Credit circuit 20 (see FIG. 1).

FIG. 4 shows a block diagram of the port logic control 310 used to control how a destination port is opened. As shown, the port commands an Open Full Duplex (e.g., buffers available); an Open Half Duplex (e.g., Tier 1 and Tier 2 actions triggered); or a Close (i.e., close the communication port) to a destination port. As evident from FIG. 4, the operation of Tier 1 and Tier 2 actions affects how port control logic 310 determines the protocol signals issued by a port. As discussed above, Tier 1 and Tier 2 modes of operation help determine whether a port sends an Open Full Duplex command, an Open Half Duplex command, or a Close command. Port logic control 310 is preferably implemented as part of protocol logic 15 (see FIG. 1).

Although described above in the context of specific embodiments, those skilled in the art should appreciate that this description is exemplary and indicative of presently preferred embodiments of the present invention, and is not to be read or construed in a limiting sense upon the invention. For example, the counters 205 and 210 may have as inputs all types of messages, such as commands, data, and status messages.

The present invention may be implemented by a computer readable storage medium. (e.g., a removable storage medium, a memory card or a hard disk) having program instructions embodied therein for executing the methods of the present invention. The computer readable storage medium can be read and the program instructions executed by a processor. Accordingly, the control of flow of command messages in a network so as to avoid an overrun of commands is accomplished by program instructions for determining the number of buffers available in a command queue by a counter circuit; and program instructions for controlling the flow of command frames by a control circuit responsive to a status of the command queue and control logic wherein the control circuit includes a first and a second threshold register.

It will be apparent, however, that various variations and modifications may be made to the invention, with the attainment of some or all of the advantages of the invention as indicated in the claims appended hereto.

What we claim is:

1. A device for controlling the flow of messages in a network so as to avoid an overrun of commands, said device comprising:
a counter circuit for determining the number of buffers available in a command queue; and
a control circuit including means for storing for controlling the flow of commands, said control circuit being responsive to a status of said command queue and control logic.

2. The device of claim 1 further comprising control logic, said control circuit being responsive to said status of said command queue and to said control logic.

3. The device of claim 1 wherein said control circuit further comprises means for comparing a threshold value and said command queue status.

4. The device of claim 1 wherein said means for storing comprises a first and second threshold register.

5. The device of claim 4 wherein said two threshold registers have different threshold values.

6. The device of claim 1 wherein said control circuit provides a first indication of said command queue status and a second indication of said command queue status.

7. The device of claim 6 wherein said first indication triggers a first action by said control circuit and said second indication triggers a second action by said control circuit, wherein said first and second actions include, at least, adjusting the ratio of commands received by said command queue to commands executed.

8. The device of claim 1 wherein said control circuit adjusts the ratio of commands incoming to the device to commands executed by the device.

9. The counter circuit of claim 1 further comprising a non-zero detect circuit for detecting whether the number of buffers available in said command queue is a non-zero value.

10. A method for controlling the flow of messages in a network so as to avoid an overrun of commands, said method comprising the steps of comprising:
determining the number of buffers available in a command queue by a counter circuit; and
controlling the flow of commands by a control circuit responsive to a status of said command queue wherein said control circuit includes means for storing.

11. The method of claim 10 wherein said step of controlling further comprises being responsive to control logic

12. The method of claim 10 wherein said step of controlling further includes comparing a threshold value and said command queue status.

13. The method of claim 10 wherein said step of determining the number of buffers available further comprises the steps of:
counting the number of command frames available; and
counting the number of reserved buffers.

14. The method of claim 10 wherein said step of controlling further comprises the steps of:
providing a first indication of said command queue status; and
providing a second indication of said command queue status.

15. The method of claim 14 further comprising the steps of triggering a first action in response to said first indication and triggering a second action in response to said second indication, wherein said first and second actions include, at least, adjusting the ratio of command frames received by said command queue to command frames executed.

16. The method of claim 10 wherein said step of controlling the flow of said commands includes the step of adjusting the ratio of commands received to frames executed.

17. The method of claim 10 wherein said step of controlling the flow of said command frames includes the step of detecting whether the number of buffers available in said command queue is a non-zero value.

18. A storage medium having computer readable program instructions embodied therein for controlling the flow of messages in a network so as to avoid an overrun of commands, said storage medium comprising:
program instructions for determining the number of buffers available in a command queue by a counter circuit; and
program instructions for controlling the flow of commands by a control circuit wherein said control circuit is responsive to a status of said command queue and includes a first and a second threshold register.
